(19) United States
(12) Patent Application Publication
(10) Pub. No.: US 2025/0306766 A1
(43) Pub. Date: Oct. 2, 2025

(54) MULTI-LEVEL ACCESS COUNTERS FOR A MEMORY DEVICE

(71) Applicant: Micron Technology, Inc., Boise, ID (US)

(72) Inventors: Alessandro ORLANDO, Milano (IT); Massimiliano TURCONI, Gorgonzola (IT); Danilo CARACCIO, Milano (IT); Brian HIRANO, Niwot, CO (US)

(21) Appl. No.: 19/063,579

(22) Filed: Feb. 26, 2025

Related U.S. Application Data
(60) Provisional application No. 63/570,481, filed on Mar. 27, 2024.

(51) Int. Cl. G06F 3/06

(52) U.S. Cl. CPC G06F 3/0613; G06F 3/0653; G06F 3/0673

(57) ABSTRACT

In some implementations, a memory device may receive a first access request indicating that a portion of a memory is to be accessed by the memory device. The memory device may identify a first-level block of memory, of multiple first-level blocks of memory, that is associated with the portion of the memory. The memory device may identify that a first access counter associated with the first-level block of memory satisfies a first-level access threshold. The memory device may identify a second-level block of memory, of multiple second-level blocks of memory, that is associated with the portion of the memory based on identifying that the first access counter satisfies the first-level access threshold. The memory device may identify that a second access counter associated with the second-level block of memory does not satisfy a second-level access threshold. The memory device may increment the second access counter.

### CROSS REFERENCE TO RELATED APPLICATION

This patent application claims priority to U.S. Provisional Patent Application No. 63/570,481, filed on Mar. 27, 2024, and entitled “MULTI-LEVEL ACCESS COUNTERS FOR A MEMORY DEVICE.” The disclosure of the prior application is considered part of and is incorporated by reference into this patent application.

### TECHNICAL FIELD

The present disclosure generally relates to memory devices, memory device operations, and, for example, to multi-level access counters for a memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of implementing multi-level access counters.

FIGS. 2A-2E are diagrams associated with an example of multi-level access counters for a memory device.

FIG. 3 is a flowchart of an example method associated with multi-level access counters for a memory device.

### DETAILED DESCRIPTION

In some memory systems, a controller may track a quantity of accesses (e.g., a quantity of read operations and/or write operations) to a portion of memory. For example, an access counter (sometimes referred to herein as a hotness counter) may be used by a memory system to determine if a certain portion of a memory is accessed relatively frequently, sometimes referred to as being “hot,” or is accessed relatively infrequently, sometimes referred to as being “cold.” In such systems, the hotness counter may be used by the memory system to make informed decisions about data management, such as by maintaining frequently accessed data (e.g., hot data) in a memory location that is easily accessible by the system in order to speed up access times, or moving rarely used data (e.g., cold data) to a slower storage, among other examples.

In some examples, tracking accesses to a memory system may involve an inherent tradeoff between a granularity at which a memory is tracked and an amount of resources consumed by tracking accesses to the memory. For example, for systems in which accesses to relatively large blocks of memory are tracked, such as blocks of memory associated with one or more gigabytes (GB) of storage, tracking accesses to the memory may be relatively efficient, because only a small quantity of hotness trackers (e.g., in some examples, eight or fewer) may be needed to track an entire device capacity and/or because relatively low amounts of storage may need to be dedicated for storing the hotness counters. However, when large blocks of memory are tracked, information provided by the hotness counters may be of limited value because a host system or other device may not be capable of determining which specific addresses within the large blocks of memory are hot. Alternatively, for systems in which accesses to relatively small blocks of memory are tracked, such as blocks of memory associated with a few kilobytes (KB) of storage, tracking accesses to the memory may be resource intensive, because a relatively large quantity of hotness counters may be needed to track an entire device capacity and/or because relatively high amounts of storage may need to be dedicated for storing the hotness counters. However, in such cases, information provided by the hotness counters may result in improved memory operations because a host system or other device may be capable of determining which specific addresses within the memory are hot.

Moreover, certain hotness tracking mechanisms may rely on statistical approaches for tracking accesses to memory, such as by using a counting bloom filter (CBF) or a similar statistical approach for determining a quantity of accesses to a given memory address. Such approaches may lead to inaccurate tracking mechanisms due to collisions at the CBF, resulting in memory decisions being made with limited and/or incorrect hotness information. This may result in inefficient memory operations and thus high power, computing, and other resource consumption.

Some implementations described herein enable multi-level hotness tracking, such as by enabling tracking of memory using decreasing tracking granularities as a portion of memory becomes hot. More particularly, a hotness monitoring unit (sometimes referred to herein as a memory access profiler) may be associated with multiple levels, such as a first-level structure that tracks accesses to a portion of a memory using a first tracking granularity (e.g., the first-level structure may be associated with multiple first-level blocks of memory, such as multiple 1 GB blocks of memory, each associated with a corresponding hotness counter), a second-level structure that tracks accesses to a portion of a memory using a second, smaller tracking granularity (e.g., the second-level structure may be associated with multiple second-level blocks of memory, such as multiple 2 megabyte (MB) blocks of memory, each associated with a corresponding hotness counter), and/or a third-level structure that tracks accesses to a portion of a memory using a third, even smaller tracking granularity (e.g., the third-level structure may be associated with multiple third-level blocks of memory, such as multiple 4 KB blocks of memory, each associated with a corresponding hotness counter). When a first-level block becomes hot, such as when a first-level hotness counter associated with a certain first-level block satisfies a first-level threshold, the first-level block may be added to a first-level hotlist (which may be a list indicating N hot blocks of memory, and thus may sometimes be referred to herein as a first-level hot N list (HN-L)), and/or the hotness monitoring unit may begin tracking the first-level block using multiple second-level blocks of memory. Similarly, when one of those second-level blocks of memory becomes hot, such as when a second-level hotness counter associated with the second-level block satisfies a second-level threshold, the second-level block may be added to a second-level hotlist (sometimes referred to herein as a second-level HN-L), and/or the hotness monitoring unit may begin tracking the hot second-level block using multiple third-level blocks of memory. Moreover, when one of those third-level blocks of memory becomes hot, such as when a third-level hotness counter associated with the third-level block satisfies a third-level threshold, the third-level block may be added to a third-level hotlist (sometimes referred to herein as a third level HN-L).

In this way, by accessing the hotlists (e.g., the first-level HN-L, the second-level HN-L, and/or the third-level HN-L), a hotness monitoring unit, a host system, and/or another entity may determine, at different granularities, which portions of the memory are the hottest. This may result in hotness monitoring mechanisms that are less resource-intensive than traditional mechanisms that rely only on relatively small tracking granularities, because cold portions of the memory may be tracked at large granularities to conserve resources. Additionally, or alternatively, this may result in hotness monitoring mechanisms that provide more useful monitoring information and thus more efficient memory operations (e.g., enabling a host system to make more effective migration and/or swap decisions for portions of memory) than traditional mechanisms that rely only on relatively large tracking granularities, because information is provided at a smaller granularity for frequently accessed portions of the memory. Additionally, or alternatively, in some implementations, the hotness tracking mechanisms described herein may result in improved tracking accuracy, because one or more levels (e.g., the first level and/or the second level) may be associated with hardware hotness counters, thereby reducing a quantity of collisions otherwise associated with statistical hotness counters, such as CBF-based hotness counters, among other examples. Additionally, or alternatively, enabling a host system and/or another monitoring unit to track accesses at multiple granularities (e.g., granularities of 1 GB, 2 MB, and/or 4 KB, among other examples) at the same time may enable extension of a quantity of (e.g., N) recently accessed memory pages (e.g., N recently accessed compute express link (CXL) pages) to multiple granularities, may enable improved hotness tracking to be performed with minimal hardware impact, and/or may enable a host system, a monitoring unit, and/or another entity to identify a global ranking of memory allocated on a memory device (e.g., a CXL device) at different page granularities. Additionally, or alternatively, enabling a host system and/or another monitoring unit to track accesses at multiple granularities may accommodate integration with certain industry operating system (OS) policies, such as integration with policies associated with a data access monitoring (DAMON) system, among other examples.

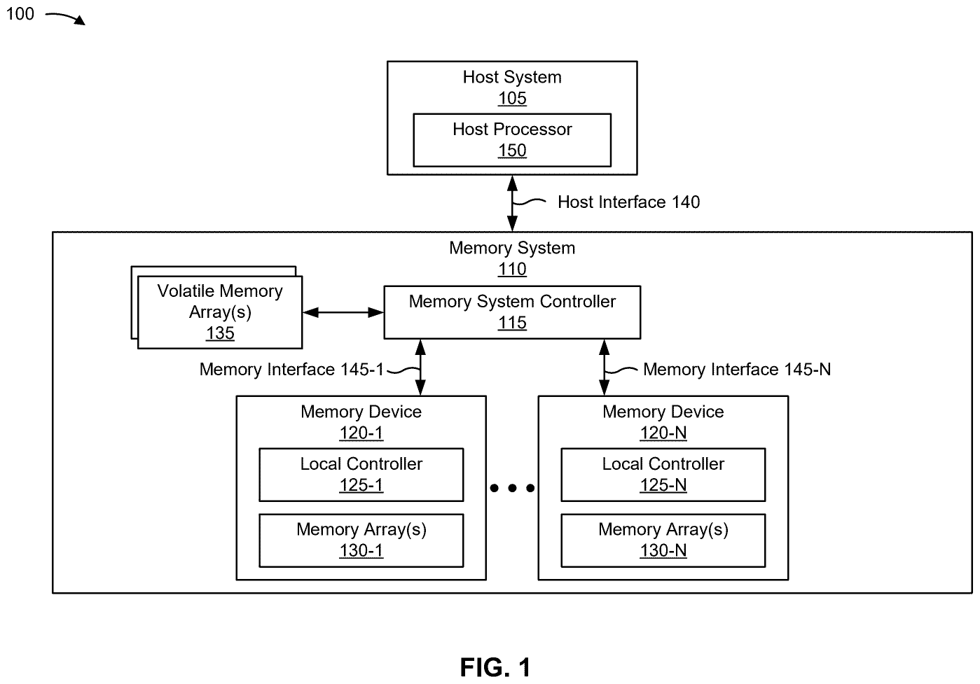

FIG. 1 is a diagram illustrating an example system 100 capable of implementing multi-level access counters. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a compute express link (CXL) controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

In some examples, the memory system 110 may be a CXL compliant memory system (sometimes referred to herein simply as a CXL memory system) and/or one or more of the memory devices 120 may be CXL compliant memory devices (sometimes referred to herein simply as CXL memory devices). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide an advanced protocol in areas such as input/output (I/O) protocol, memory protocol, and coherency interface.

In some examples, the memory system 110 may include a PCIe/CXL interface (e.g., the host interface 140 may be associated with a PCIe/CXL interface), which may be a physical interface configured to connect the CXL memory system and/or the CXL memory device to CXL compliant host devices. In such examples, the PCIe/CXL interface may comply with CXL standard specifications for physical connectivity, ensuring broad compatibility and ease of integration into existing systems using the CXL protocol. Additionally, or alternatively, a CXL memory system and/or a CXL memory device may be designed to efficiently interface with computing systems (e.g., the host system 105) by leveraging the CXL protocol. For example, a CXL memory system and/or a CXL memory device may be configured to utilize high-speed, low-latency interconnect capabilities of CXL, such as for a purpose of making the CXL memory system and/or the CXL memory device suitable for high-performance computing, data center applications, artificial intelligence (AI) applications, and/or similar applications.

A CXL memory system and/or a CXL memory device may include a CXL memory controller (e.g., memory system controller 115 and/or local controller 125), which may be configured to manage data flow between memory arrays (e.g., volatile memory arrays 135 and/or memory arrays 130) and a CXL interface (e.g., a PCIe/CXL interface, such as host interface 140). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

A CXL memory system and/or a CXL memory device may further include and/or be associated with one or more high-bandwidth memory modules (HBMMs) or similar memory arrays (e.g., volatile memory arrays 135 and/or memory arrays 130). For example, a CXL memory system and/or a CXL memory device may include multiple layers of DRAM (e.g., stacked and/or interconnected through advanced through-silicon via (TSV) technology) in order to maximize storage density and/or enhance data transfer speeds between memory layers. Additionally, or alternatively, a CXL memory system and/or a CXL memory device may include a power management unit, which may be configured to regulate power consumption associated with the CXL memory system and/or the CXL memory device and/or which may be configured to improve energy efficiency for the CXL memory system and/or the CXL memory device. Additionally, or alternatively, a CXL memory system and/or a CXL memory device may include additional components, such as one or more error correction code (ECC) engines, such as for a purpose of detecting and/or correcting data errors to ensure data integrity and/or improve the overall reliability of the CXL memory system and/or the CXL memory device.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, a first access request indicating that a portion of a memory is to be accessed; identify a first-level block of memory, of multiple first-level blocks of memory, that is associated with the portion of the memory; identify that a first access counter associated with the first-level block of memory satisfies a first-level access threshold; identify a second-level block of memory, of multiple second-level blocks of memory, that is associated with the portion of the memory based on identifying that the first access counter satisfies the first-level access threshold; identify that a second access counter associated with the second-level block of memory does not satisfy a second-level access threshold; and increment the second access counter.

In some implementations, one or more systems, devices, apparatuses, components, and/or controllers of FIG. 1 may be associated with a CXL compliant memory device and/or may be configured to receive, from a host system, a first access request indicating that a portion of a memory is to be accessed by the CXL compliant memory device; identify a first-level block of memory, of multiple first-level blocks of memory, that is associated with the portion of the memory; increment a first hotness counter associated with the first-level block of memory; identify that the first hotness counter satisfies a first-level hotness threshold; add an identifier of the first-level block of memory to a first-level hotlist based on identifying that the first hotness counter satisfies the first-level hotness threshold; receive, from the host system, a second access request indicating that the portion of the memory is to be accessed by the CXL compliant memory device; identify a second-level block of memory, of multiple second-level blocks of memory, that is associated with the portion of the memory; increment a second hotness counter associated with the second-level block of memory; identify that the second hotness counter satisfies a second-level hotness threshold; add an identifier of the second-level block of memory to a second-level hotlist based on identifying that the second hotness counter satisfies the second-level hotness threshold; receive, from the host system, a third access request indicating that the portion of the memory is to be accessed by the CXL compliant memory device; identify a third-level block of memory, of multiple second-level blocks of memory; increment a third hotness counter associated with the third-level block of memory; identify that the third hotness counter satisfies a third-level hotness threshold; and add an identifier of the third-level block of memory to a third-level hotlist based on identifying that the third hotness counter satisfies the third-level hotness threshold.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

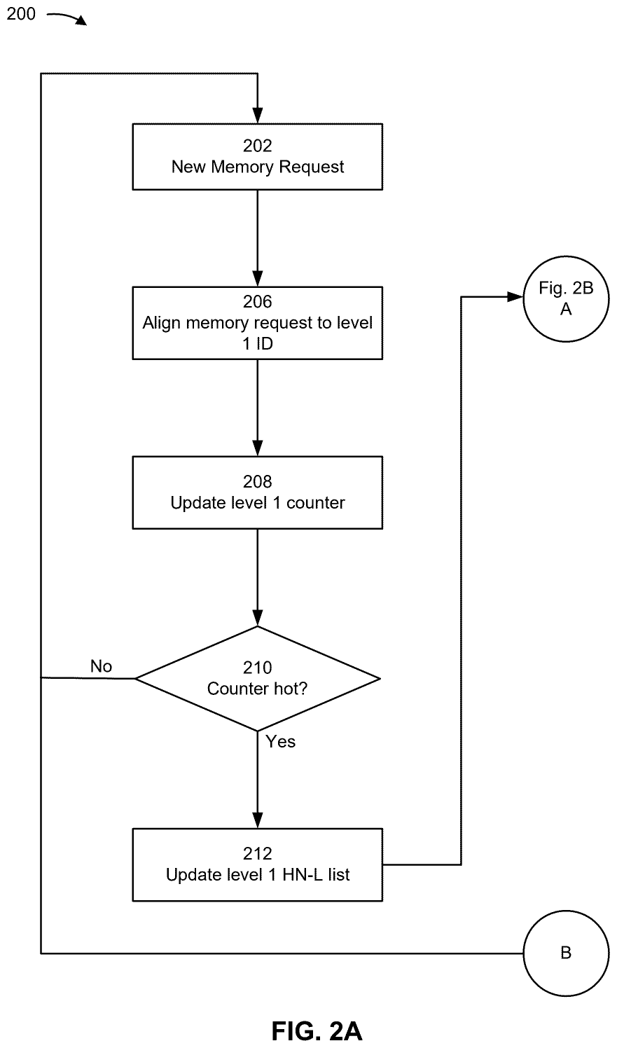

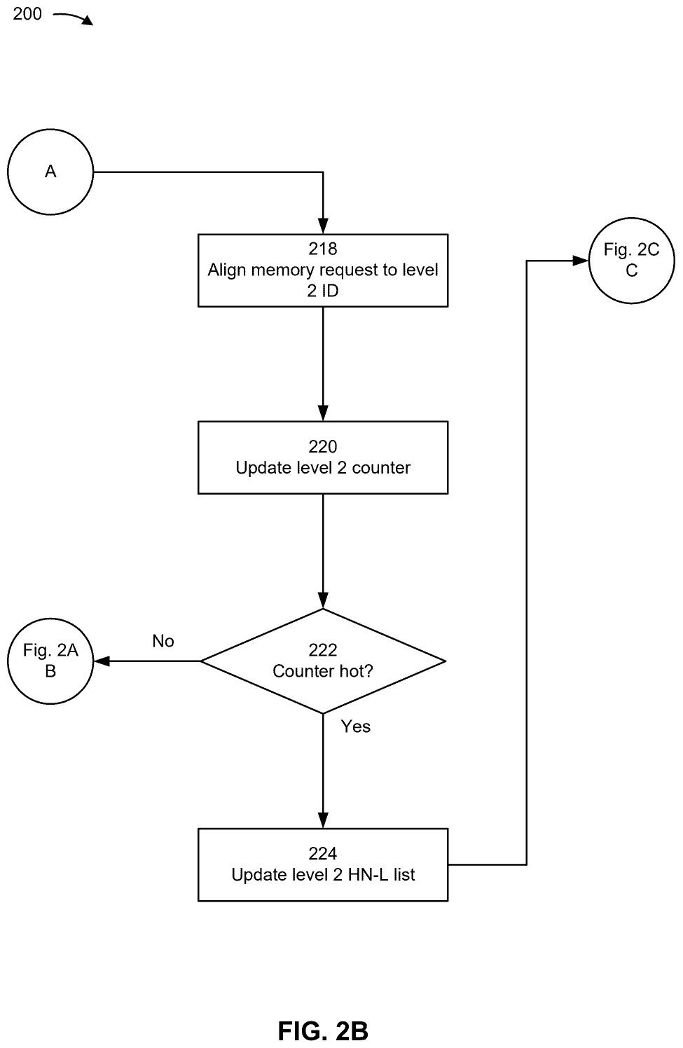

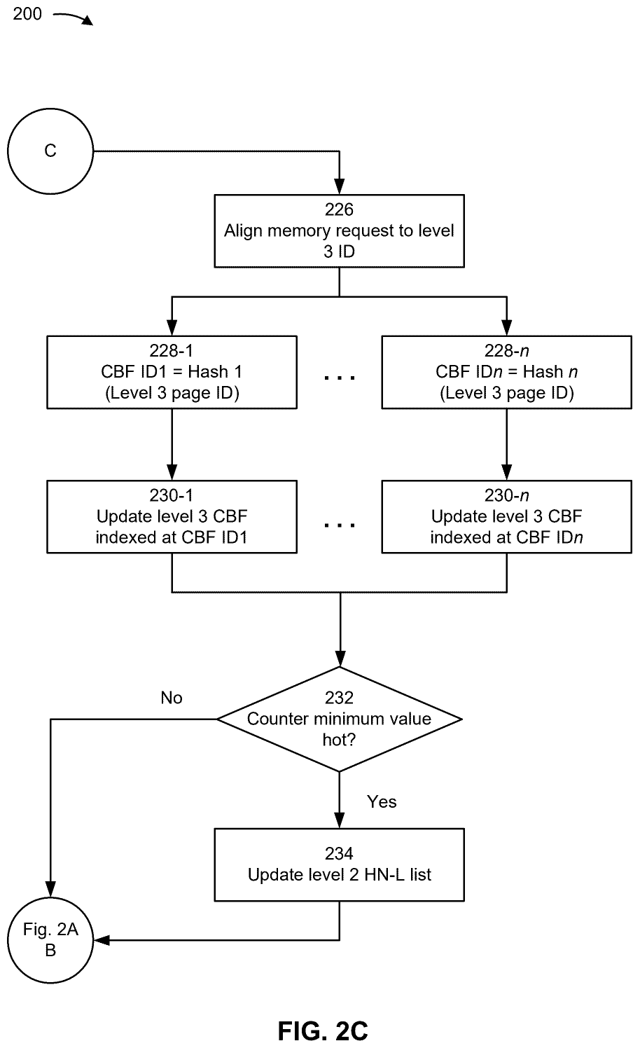

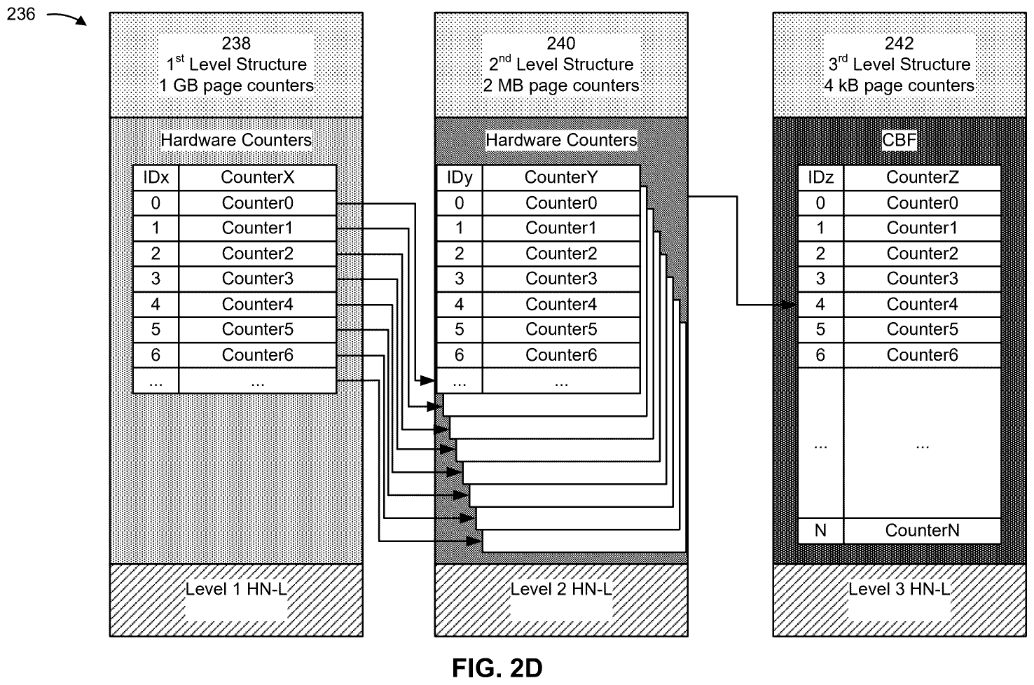

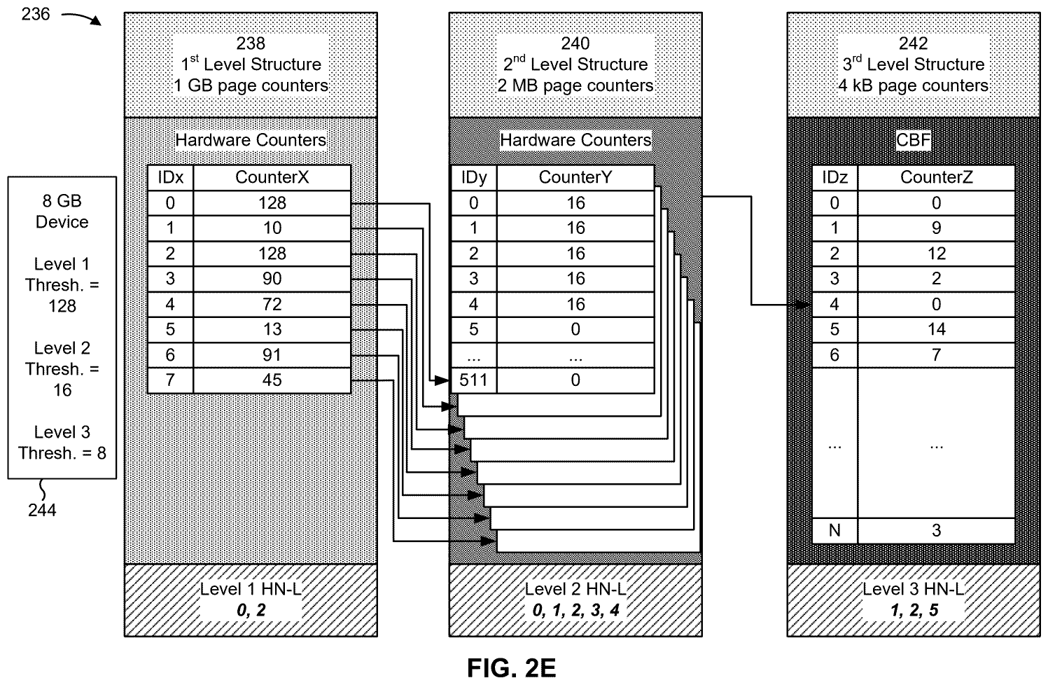

FIGS. 2A-2E are diagrams associated with an example of multi-level access counters for a memory device. The operations described in connection with FIGS. 2A-2E may be performed by the memory system 110 and/or one or more components of the memory system 110, such as the memory system controller 115, one or more memory devices 120, and/or one or more local controllers 125.

In some implementations, a memory device (e.g., a CXL memory device) may utilize multi-level hotness tracking mechanisms for tracking hot portions of a memory. For example, one or more tracking levels (sometimes referred to herein as a first-level structure and/or a second-level structure) may be associated with hardware hotness counters and/or relatively large tracking granularities, and one or more other tracking levels (sometimes referred to herein a third-level structure) may be associated with a statistical-based hotness counter (such as a CBF-based hotness counter) and/or relatively small tracking granularities. For example, a first-level structure may track memory requests at a 1 GB block granularity using a hardware-based hotness counter, a second level structure may track memory requests at a 2 MB block granularity using a hardware-based hotness counter, and/or a third level structure may track memory requests at a 4 KB page granularity using a CBF-based hotness counter, among other examples.

In some implementations, as accesses to a portion of a memory are tracked by a hotness monitoring unit or a similar component of the memory device, the portion of the memory may be first tracked using the first-level structure (e.g., a hardware-based hotness counter), such as by aligning memory requests to a granularity of 1 GB. When a first-level memory block becomes hot (e.g., when a first-level hotness counter associated with a first-level memory block, such as group of memory addresses encompassing 1 GB of memory, satisfies a first-level threshold), the hotness monitoring unit may begin tracking accesses to the portions of memory associated with the hot first-level memory block using the second-level structure (e.g., using another hardware-based hotness counter), such as by aligning memory requests to a granularity of 2 MB. Similarly, when a second-level block becomes hot (e.g., when a second-level hotness counter associated with a second-level memory block, such as a group of addresses encompassing 2 MB of memory, satisfies a second-level threshold), the hotness monitoring unit may begin tracking accesses to the portions of memory associated with the hot second-level memory block using the third-level structure (e.g., a CBF-based hotness counter), such as by aligning memory requests to a granularity of 4 KB.

In some implementations, a hotness threshold for each level may be a configurable parameter. For example, a host system (e.g., host system 105) or a similar device may set a hotness threshold for each level using one or more registers associated with the memory device (e.g., one or more registers stored at a CXL device, among other examples). Additionally, or alternatively, each level may be associated with a corresponding hotlist (e.g., HN-L), which may be a data structure indicating a quantity of (e.g., N) hottest memory blocks for the respective level. In this way, by reading the hotlists, a hotness monitoring unit, a host system, and/or another device may determine, at different granularities, which blocks of memory are the hottest.

In some implementations, the hotness counters (e.g., the one or more hardware-based counters associated with the first-level structure and/or the second-level structure, and/or the CBF-based hotness counter associated with the third-level structure, among other examples) and/or the hotlists (e.g., the first-level HN-L, the second-level HN-L, and/or the third-level HN-L) may be aged (e.g., reset to zero or reduced according to a configurable reduction factor) after a counting session (sometimes referred to herein as a counting period, a hotness counting period, a monitoring session, a monitoring period, and/or an epoch). For example, the memory device may receive configuration information via one or more registers indicating whether the hotness counters and/or the hotlists are to be aged at an end of an epoch, a length of the epoch, and/or an aging type to be performed (e.g., whether the HN-Ls and/or the hotness counters are to be reset or else reduced according to a configured reduction factor), among other examples. Additionally, or alternatively, a policy of memory block placement (e.g., a determination as to memory locations that are to be written to, among other examples) based on the hotness information may be implemented on a host side (e.g., the host system 105 may implement a policy of page placement) based on information provided by the multi-level hotness counters.

More particularly, FIGS. 2A-2C show an example process 200 associated with multi-level hotness counters for a memory device. For ease of description, the operations shown and described in connection with the example process 200 are described as being performed by a memory device; however, in some implementations one or more dedicated components of a memory device (e.g., a hotness monitoring unit of a memory device; a controller of a memory device, such as the memory system controller 115 and/or the local controller 125; and/or other components of a memory device) may perform the operations of the example process 200. Additionally, or alternatively, the operations shown in connection with the example process 200 may be associated with a CXL device. For example, the operations shown in connection with the example process 200 may be performed by a hotness monitoring unit of a CXL device, which may be a component of a CXL controller (e.g., an ASIC) that is capable of monitoring accesses to memory (e.g., DRAM) associated with the CXL device.

As indicated by reference number 202, in some implementations, the memory device may receive a new memory request (sometimes referred to herein as an access request), which may be a request from a host system (e.g., host system 105) to access a portion of a memory (e.g., a request to read the portion of the memory and/or a request to write to the portion of the memory, among other examples). For example, in implementations in which the memory device is a CXL device, the memory device may receive a CXL.mem request from a host system (sometimes referred to as a CXL host) that is connected to the CXL device via a PCIe/CXL interface. In some implementations, the CXL.mem request may be a memory read (MemRd) request, which may be a request used by the host system to read data from a memory (e.g., DRAM memory and/or similar memory) of the CXL device. In such examples, the MemRd request may initiate a read operation to fetch data from a specific memory location at the CXL device. In some other implementations, the CXL.mem request may be a memory read with trusted execution environment (MemRdTEE) request, which may be similar to a MemRd request but which may be used specifically when accessing memory regions protected by a trusted execution environment (TEE). In some other implementations, the CXL.mem request may be a memory speculative read (MemSpecRd) request, which may be a request used for speculative reads (e.g., reads in which the host system anticipates requiring certain data before the data is actually requested). In such examples, the MemSpecRd request may be used to prefetch data into caches or similar portions of memory, such as for a purpose of reducing latency when the data is later needed by the host system. In some other implementations, the CXL.mem request may be a memory speculative read with TEE (MemSpecRdTEE) request, which may be similar to a MemSpecRd request but which may be used specifically when accessing memory regions protected by a TEE.

In some other implementations, the CXL.mem request may be a memory write (MemWr) request, which may be a request used by the host system to write data to the memory of the CXL device. In such examples, the MemWr request may initiate a write operation, such as by providing the data to be written and a destination address for the data. In some other implementations, the CXL.mem request may be a memory write with partial (MemWrPtl) request, which may be a request used by the host system when only a portion of the data is being modified in a memory location. In such examples, the MemWrPtl request may specify the data to be written and a byte mask indicating which bytes in the memory location should be updated. In some other implementations, the CXL.mem request may be a memory write with TEE (MemWrTEE) request, which may be similar to a MemWr request but which may be used specifically when writing to memory regions protected by a TEE. In some other implementations, the CXL.mem request may be a memory write with partial and TEE (MemWrPtlTEE) request, which may be similar to a MemWrPtl request but which may be used specifically when writing to memory regions protected by a TEE.

As shown by reference number 206, based on receiving the new memory request, the memory device may align the memory request to a first-level identifier (ID). Put another way, the memory device may identify a first-level block of memory that is associated with the portion of the memory indicated by the memory request. As described above, in some implementations the first-level block of memory (sometimes referred to as a first-level page of memory) may be associated with a relatively large granularity, such as 1 GB, or the like. Accordingly, in such implementations, the memory device may identify the 1 GB block of memory that encompasses the one or more memory addresses indicated by the memory request.

As indicated by reference number 208, the memory device may update a first-level hotness counter (e.g., a first-level access counter) associated with the first-level block of memory identified in the operations described above in connection with reference number 206. In some implementations, the memory device may utilize a hardware-based hotness counter for tracking accesses to the first-level blocks of memory. A hardware-based hotness counter may be a counter implemented within a memory controller (e.g., memory system controller 115 and/or local controller 125, among other examples), such as within a CXL controller (e.g., ASIC) of a CXL device. Whenever an access (e.g., a read or write) to a particular memory region occurs, the memory device may increment the corresponding hardware counter associated with that region. In some implementations, because the tracking process happens directly in hardware without involving software intervention, hardware-based hotness counters may be more efficient than other types of hotness counters, such as CBF-based hotness counters, among other examples. In that regard, based on receiving the memory request indicating an address range encompassed by the first-level block of memory, the memory device may increment the first-level access counter associated with the first-level block of memory (e.g., the hardware-based counter corresponding to the accessed first-level block of memory).

Moreover, as indicated by reference number 210, the memory device may determine whether the first-level block of memory and/or the corresponding first-level hotness counter associated with the first-level block of memory has become hot. For example, the memory device may be configured (e.g., by the host system 105 via one or more registers, among other examples) with a first-level hotness threshold (sometimes referred to herein as a first-level access threshold). In such implementations, the memory device may compare the first-level hotness counter to the first-level hotness threshold. If the first-level hotness counter does not satisfy the first-level hotness threshold (shown as “no” in connection with the operations indicated by reference number 210), indicating that the first-level block of memory (e.g., the 1 GB block of memory) has not become hot, the example process may return to the block indicated by reference number 202 (e.g., the memory device may wait for the next memory request received from the host system).

However, if the first-level hotness counter satisfies the first-level hotness threshold, indicating that the first-level block of memory (e.g., the 1 GB block of memory) has become hot, the memory device may update a first-level hotlist (e.g., the first-level HN-L) to include the first-level block of memory. More particularly, the memory device may add an ID of the first-level block of memory to the first-level hotlist based on identifying that the first-level hotness counter satisfies the first-level hotness threshold. The example process 200 may then proceed to the operations shown on FIG. 2B.

More particularly, as indicated by reference number 218, the memory device may align the memory request to a second-level ID. Put another way, the memory device may identify a second-level block of memory that is associated with the portion of the memory indicated by the memory request. As described above, in some implementations the second-level block of memory (sometimes referred to as a second-level page of memory) may be associated with a medium-size granularity, such as 2 MB, or the like. Accordingly, in such implementations, the memory device may identify the 2 MB block of memory that encompasses the one or more memory addresses indicated by the memory request.

As indicated by reference number 220, the memory device may update a second-level hotness counter (e.g., a second-level access counter) associated with the second-level block of memory identified in the operations described above in connection with reference number 218. In some implementations, and in a similar manner as used to track accesses to the first-level blocks of memory, the memory device may utilize a hardware-based hotness counter for tracking accesses to the second-level blocks of memory. In such implementations, the memory device may increment the second-level access counter associated with the second-level block of memory (e.g., the hardware-based hotness counter associated with the one or more memory addresses indicated by the memory request). Moreover, as indicated by reference number 222, the memory device may determine whether the second-level block of memory and/or the corresponding second-level hotness counter associated with the second-level block of memory has become hot. For example, the memory device may be configured (e.g., by the host system 105 via one or more registers, among other examples) with a second-level hotness threshold (sometimes referred to herein as a second-level access threshold). In such implementations, the memory device may compare the second-level hotness counter to the second-level hotness threshold. If the second-level hotness counter does not satisfy the second-level hotness threshold (shown as “no” in connection with the operations indicated by reference number 222), indicating that the second-level block of memory (e.g., the 2 MB block of memory) has not become hot, the example process may return to the block indicated by reference number 202 (e.g., the memory device may wait for the next memory request received from the host system).

However, if the second-level hotness counter satisfies the second-level hotness threshold, indicating that the second-level block of memory (e.g., the 2 MB block of memory) has become hot, the memory device may update a second-level hotlist (e.g., the second-level HN-L) to include the second-level block of memory. More particularly, the memory device may add an ID of the second-level block of memory to the second-level hotlist based on identifying that the second-level hotness counter satisfies the second-level hotness threshold. The example process 200 may then proceed to the operations shown on FIG. 2C.

More particularly, as indicated by reference number 226, the memory device may align the memory request to a third-level ID. Put another way, the memory device may identify a third-level block of memory that is associated with the portion of the memory indicated by the memory request. As described above, in some implementations the third-level block of memory (sometimes referred to as a third-level page of memory) may be associated with a small granularity, such as 4 KB, or the like. Accordingly, in such implementations, the memory device may identify the 4 KB block of memory that encompasses the one or more memory addresses indicated by the memory request.

In some implementations, a hotness counter associated with the third-level structure may be a statistical-based hotness counter, such as a CBF-based hotness counter. A CBF may utilize a probabilistic solution that counts elements of a data stream. In the context of a hotness counter, such as a hotness counter associated with a CXL device, a CBF may be used to estimate an access frequency on a particular CXL.mem channel. In such implementations, a discrete physical address (DPA) of an incoming memory request may be decoded and aligned to a third-level memory block (e.g., a 4 KB block), such as for a purpose of deriving a third-level ID associated with the memory request. Moreover, the third-level ID may be hashed into multiple (e.g., n) hash functions to derive indexes in the CBF where counters are incremented. More particularly, as shown by reference numbers 228-1 through 228-n, the third-level ID may be inserted into n hash functions to obtain n CBF indexes (shown as CBF ID1 through CBF IDn). Moreover, as shown by reference numbers 230-1 through 230-n, the third-level hotness counters associated with each ID obtained in the operations described above in connection with reference numbers 228-1 through 228-n (e.g., CBF ID1 through CBF IDn) may be updated (e.g., incremented).

Moreover, as indicated by reference number 232, the memory device may determine whether the third-level block of memory and/or the corresponding third-level hotness counter associated with the third-level block of memory has become hot. For example, the memory device may be configured (e.g., by the host system 105, via one or more registers, among other examples) with a third-level hotness threshold (sometimes referred to herein as a third-level access threshold). In such implementations, the memory device may determine a minimum value of the n-indexed third-level counters described above in connection with reference numbers 230-1 through 230-n and/or the memory device may compare the minimum value of the n-indexed third-level counters to the third-level hotness threshold. If the minimum value of the n-indexed third-level counters does not satisfy the third-level hotness threshold (shown as “no” in connection with the operations indicated by reference number 232), indicating that the third-level block of memory (e.g., the 4 KB block of memory) has not become hot, the example process may return to the block indicated by reference number 202 (e.g., the memory device may wait for the next memory request received from the host system).

However, if the minimum value of the n-indexed third-level counters satisfies the third-level hotness threshold, indicating that the third-level block of memory (e.g., the 4 KB block of memory) has become hot, the memory device may update a third-level hotlist (e.g., the third-level HN-L) to include the third-level block of memory, as indicated by reference number 234. More particularly, the memory device may add an ID of the third-level block of memory to the third-level hotlist based on identifying that the minimum value of the n-indexed third-level counters satisfies the third-level hotness threshold. Aspects of using a CBF-based hotness counter for tracking accesses to the third-level blocks of memory (e.g., 4 KB blocks of memory) are described in more detail below in connection with FIG. 2E. The example process 200 may then return to the block indicated by reference number 202. More particularly, the memory device may wait for the next memory request (e.g., the next CXL.mem request) received from the host system, using which the memory device may proceed through the steps shown in FIGS. 2A-2C in a substantially similar manner as described above.

FIGS. 2D-2E depict an example 236 of multi-level structures that may be used in connection with multi-level hotness counters, such as in connection with the example process 200 described above in connection with FIGS. 2A-2C. As shown in FIG. 2D, the multi-level hotness counters may be associated with a first-level structure, indicated by reference number 238. The first-level structure may be associated with multiple first-level hotness counters (e.g., multiple first-level access counters), such as multiple 1 GB hotness counters. In the example 236, the first-level structure may be associated with multiple hardware-based hotness counters, but, in some other implementations, the first-level structure may be associated with a different type of hotness counters (e.g., statistical-based hotness counters). The multiple first-level hotness counters are indicated in the first-level structure using a single table listing an ID associated with each first-level block and/or page of memory (shown in connection with reference number 238 as “IDx”) and, for each ID, a corresponding hotness counter value (shown in connection with reference number 238 as “CounterX”). Additionally, or alternatively, the first-level structure may be associated with a first-level hotlist (shown in connection with reference number 238 as a “Level 1 HN-L”), which may be used to store IDs of the blocks and/or pages of memory that have become hot (e.g., IDs of the first-level blocks of memory for which a corresponding hotness counter satisfies a first-level threshold).

Moreover, the multi-level hotness counters may further be associated with a second-level structure, indicated by reference number 240. The second-level structure may be associated with multiple second-level hotness counters (e.g., multiple second-level access counters), such as multiple 2 MB hotness counters. In the example 236, the second-level structure may be associated with multiple hardware-based hotness counters, but, in some other implementations, the second-level structure may be associated with a different type of hotness counters (e.g., statistical-based hotness counters). In some implementations, each hot first-level block of memory may be partitioned into multiple second-level blocks of memory, such as for a purpose of finer-granularity tracking, as described above. Accordingly, as shown using arrows in the example 236, a given first-level block of memory may be associated with multiple second-level blocks of memory. For example, each first-level block of memory (e.g., each 1 GB block of memory) may be associated with the multiple second-level blocks of memory (e.g., 512 2 MB blocks of memory) that are indicated in a single table, pointed to by a corresponding arrow, for the first-level block of memory listing an ID associated with each second-level block and/or page of memory (shown in connection with reference number 240 as “IDy”) and, for each ID, a corresponding hotness counter value (shown in connection with reference number 240 as “CounterY”). Additionally, or alternatively, the second-level structure may be associated with a second-level hotlist (shown in connection with reference number 240 as a “Level 2 HN-L”), which may be used to store an ID of the blocks and/or pages of memory that have become hot (e.g., the IDs of the second-level blocks of memory for which a corresponding hotness counter satisfies a second-level threshold).

Moreover, the multi-level hotness counters may be associated with a third-level structure, indicated by reference number 242. The third-level structure may be associated with multiple third-level hotness counters (e.g., multiple third-level access counters), such as multiple counters used to track 4 KB blocks of memory. In the example 236, the third-level structure may be associated with a CBF with N elements, indicated in the table shown in connection with reference number 242 by an ID associated with each third-level block and/or page of memory (shown in connection with reference number 242 as “IDz”) and, for each ID, a corresponding hotness counter value (shown in connection with reference number 242 as “CounterZ”). In some other implementations, the third-level structure may be associated with a different type of hotness counters (e.g., hardware-based hotness counters). Additionally, or alternatively, the third-level structure may be associated with a third-level hotlist (shown in connection with reference number 242 as a “Level 3 HN-L”), which may be used to store IDs of the blocks and/or pages of memory that have become hot (e.g., the IDs of the third-level blocks of memory for which a corresponding hotness counter satisfies a third-level threshold).

FIG. 2E depicts a numerical example of how the multi-level hotness counters of example 236 may be used to track accesses (e.g., CXL.mem requests) associated with a memory (e.g., DRAM of a CXL device). As indicated by reference number 244, in this example the memory device may be an 8 GB device. The 8 GB device may have a first-level structure made up of eight 1 GB counters (indexed as ID 0 through ID 7 in FIG. 2E, such that ID 0 corresponds to a memory address range between 0-1 GB, ID 1 corresponds to a memory address range between 1-2 GB, ID 2 corresponds to a memory address range between 2-3 GB, ID 3 corresponds to a memory address range between 3-4 GB, ID 4 corresponds to a memory address range between 4-5 GB, ID 5 corresponds to a memory address range between 5-6 GB, ID 6 corresponds to a memory address range between 6-7 GB, and/or ID 7 corresponds to a memory address range between 7-8 GB). Additionally, or alternatively, the 8 GB device may have a second-level structure made up of eight groups of 512 counters (indexed as ID 0 through ID 511 in FIG. 2E), with each group of 512 counters corresponding to a respective one of the unit IDs shown in connection with the first-level structure. Additionally, or alternatively, the 8 GB device may have a third-level structure made up of a CBF having N counters (indexed as ID 0 through ID N in FIG. 2E). Moreover, and as further indicated by reference number 244, the memory device may be configured with a first-level hotness threshold (shown in FIG. 2E as “Level 1 Thresh.”) of 128, a second-level hotness threshold (shown in FIG. 2E as “Level 2 Thresh.”) of 16, and/or a third-level hotness threshold (shown in FIG. 2E as “Level 3 Thresh.”) of 8.

As shown in connection with the table of the first-level structure, the memory address range between 0-1 GB (e.g., the first-level block of memory associated with ID 0) and the memory address range between 2-3 GB (e.g., the first-level block of memory associated with ID 2) may have been accessed at least 128 times during a given epoch, and thus may be considered to be hot by the memory device (e.g., a hotness monitoring unit of the memory device). The other memory address ranges associated with the first-level structure (e.g., the first-level blocks of memory associated with IDs 1 and IDs 3-7) may have been accessed less than 128 times during the given epoch, and thus may be considered to be cold by the memory device. In that regard, the memory address range between 0-1 GB (e.g., the first-level block of memory associated with ID 0) and the memory address range between 2-3 GB (e.g., the first-level block of memory associated with ID 2) may be added to the first-level hotlist (e.g., the Level 1 HN-L), as shown.

Moreover, based on the memory address range between 0-1 GB (e.g., the first-level block of memory associated with ID 0) and the memory address range between 2-3 GB (e.g., the first-level block of memory associated with ID 2) satisfying the first-level hotness threshold (e.g., 128 in this example), the memory device may track accesses to those memory address ranges using the second-level structure (e.g., the memory device may track those memory address ranges using a 2 MB granularity). For example, the table visible in FIG. 2E may be associated with the memory address range between 0-1 GB (e.g., the first-level block of memory associated with ID 0). As shown, the memory address range between 0-1 GB may be partitioned into 512 blocks of memory, each associated with 2 MB of memory. Thus, ID 0 in the second-level structure table may correspond to a second-level block of memory associated with a memory address range between 0-2 MB, ID 1 in the second-level structure table may correspond to a second-level block of memory associated with a memory address range between 2-4 MB, ID 2 in the second-level structure table may correspond to a second-level block of memory associated with a memory address range between 4-6 MB, and so forth.

In this example, the memory address ranges associated with 0-2 MB (e.g., ID 0), 2-4 MB (e.g., ID 1), 4-6 MB (e.g., ID 2), 6-8 MB (e.g., ID 3), and 8-10 MB (e.g., ID 4) may have been accessed at least 16 times during a given epoch, and thus may be considered to be hot by the second-level structure. The other memory address ranges associated with the second-level structure (e.g., the first-level blocks of memory associated with IDs 5-511) may have been accessed less than 16 times during the given epoch, and thus may be considered to be cold by the second-level structure. In that regard, the memory address ranges associated with 0-2 MB (e.g., the second-level block of memory associated with ID 0), 2-4 MB (e.g., the second-level block of memory associated with ID 1), 4-6 MB (e.g., the second-level block of memory associated with ID 2), 6-8 MB (e.g., the second-level block of memory associated with ID 3), and 8-10 MB (e.g., the second-level block of memory associated with ID 4) may be added to the second-level hotlist (e.g., the Level 2 HN-L), as shown.

Moreover, based on the memory address ranges associated with 0-2 MB (e.g., ID 0), 2-4 MB (e.g., ID 1), 4-6 MB (e.g., ID 2), 6-8 MB (e.g., ID 3), and 8-10 MB (e.g., ID 4) satisfying the second-level hotness threshold (e.g., 16 in this example), the memory device may track the memory address ranges using the third-level structure. More particularly, the memory device may track the memory address ranges using a 4 KB granularity and/or using a CBF-based hotness counter associated with N elements. In some implementations, the CBF-based hotness counter (e.g., the hotness counter associated with the third-level structure and/or used to track memory accesses at a 4 KB granularity) may implement a bloom filter, which is a space-efficient probabilistic data structure used to test whether an element is a member of a set. In some implementations, the bloom filter may work by hashing elements into a bit array, with multiple hash functions being used to map elements to several bits in the array. A CBF may associate a counter with each bit (rather than a simple binary value, 0 or 1), with the counter keeping track of a quantity of times that an element has been hashed to that specific bit position. In that regard, when the memory device accesses a memory location (e.g., a first-level memory block), an address of the memory location may be hashed using multiple hash functions, with the resulting hash values being used to index the CBF. Moreover, counters associated with the corresponding bits in the CBF may be incremented.

Over time (e.g., over an epoch), as accesses to different memory regions occur, the counters associated with the bits in the CBF may reflect a frequency of access to each region. For example, as shown in FIG. 2E, the memory regions associated with ID 1, ID 2, and ID 5 may have been accessed at least 8 times during a given epoch, and thus may be considered to be hot by the memory device. The other memory address ranges associated with the third-level structure may have been accessed less than 8 times during the given epoch, and thus may be considered to be cold by the memory device. In that regard, IDs 1, 2, and 5 may be added to the third-level hotlist (e.g., the Level 3 HN-L), as shown.

In some implementations, each of the N elements in the CBF may correspond to a set of overlapping third-level blocks of memory (e.g., each of the N elements may indicate a quantity of accesses associated with partially overlapping subsets of addresses). Accordingly, a minimum value of the multiple elements associated with a given address (e.g., a given third-level block of memory) may indicate a highest quantity of accesses that may have been performed on a given address. Accordingly, in such implementations, the memory device may determine whether a minimum value of the multiple elements associated with a given third-level block of memory satisfies the third-level threshold (e.g., 8 in the example shown in FIG. 2E), and, if so, may add the third-level block of memory to the third-level hotlist (e.g., Level 3 HN-L).

In some implementations, the multi-level hotness counters (such as the multi-level structures described above in connection with example 236) may be implemented in a global fabric attached memory (GFAM) device, such as a CXL device that is capable of being accessed by multiple host systems (e.g., multiple host systems 105) that may be directly connected to the CXL device and/or that may be connected to the CXL device through a CXL switch, among other examples. In such implementations, the multiple host systems may require tracking accesses at different counting granularities (e.g., 4 KB, 2 MB, and/or 1 GB, among other examples), and thus the multi-level hotness counters may be used to provide useful information to each host system. Additionally, or alternatively, the multi-level hotness counters (such as the multi-level structures described above in connection with example 236) may be implemented in connection with a data access monitoring (DAMON) system, such as by enabling memory operations at memory regions having multiple sizes that change dynamically based on a hotness (e.g., such as by enabling splitting and/or merging of memory regions).

Additionally, or alternatively, the multi-level hotness counters (such as the multi-level structures described above in connection with example 236) may be implemented in connection with multi-tenant systems and/or containers (e.g., a container-based processing environment), such as by enabling guest OSs in virtual machines running on a host system to track accesses at different granularities (e.g., determined according to an OS physical page size that is to be managed). Additionally, or alternatively, the multi-level hotness counters (such as the multi-level structures described above in connection with example 236) may be implemented in enterprise-class databases and similar applications that track utilization over various regions.

Additionally, or alternatively, the multi-level hotness counters (such as the multi-level structures described above in connection with example 236) may be implemented in applications utilizing device (dev) direct access (dax) architectures (e.g., applications utilizing/dev/dax files in the Linux kernel), which may be used by host systems or the like to directly access memory without involving the operating system's page cache. Additionally, or alternatively, the multi-level hotness counters (such as the multi-level structures described above in connection with example 236) may be implemented in connection with software running on a host system that may need to detect accesses (e.g., reads and/or writes) from applications, such as security software, diagnostic software, and/or similar types of software. Additionally, or alternatively, the multi-level hotness counters (such as the multi-level structures described above in connection with example 236) may be implemented in systems used to detect memory utilization, such as for a purpose of correcting overprovisioned memory.

As indicated above, FIGS. 2A-2E are provided as an example. Other examples may differ from what is described with regard to FIGS. 2A-2E.

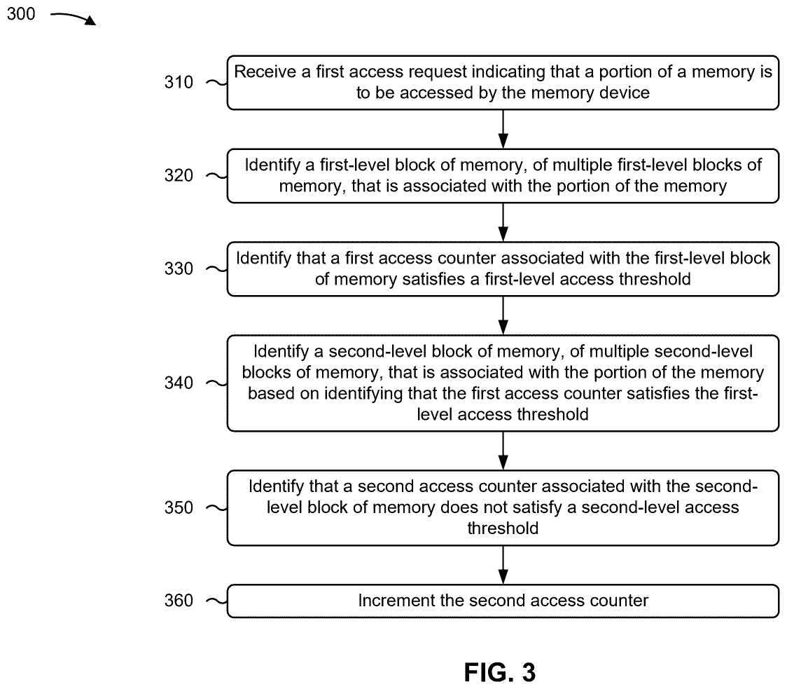

FIG. 3 is a flowchart of an example method 300 associated with multi-level access counters for a memory device. In some implementations, a memory device (e.g., the memory device 120) may perform or may be configured to perform the method 300. In some implementations, another device or a group of devices separate from or including the memory device (e.g., the system 100) may perform or may be configured to perform the method 300. Additionally, or alternatively, one or more components of the memory device (e.g., the memory system controller 115, the local controller 125, and/or one or more of the structures and/or access counters described above in connection with FIGS. 2D-2E) may perform or may be configured to perform the method 300. Thus, means for performing the method 300 may include the memory device and/or one or more components of the memory device. Additionally, or alternatively, a non-transitory computer-readable medium may store one or more instructions that, when executed by the memory device (e.g., the local controller 125 of the memory device 120), cause the memory device to perform the method 300.

As shown in FIG. 3, the method 300 may include receiving a first access request indicating that a portion of a memory is to be accessed by the memory device (block 310). For example, a CXL device may receive a CXL.mem request, as described above in connection with reference number 206. As further shown in FIG. 3, the method 300 may include identifying a first-level block of memory, of multiple first-level blocks of memory, that is associated with the portion of the memory (block 320). For example, the CXL device may align a memory address indicated by a CXL.mem request to a 1 GB block of memory, as described above in connection with reference number 206. As further shown in FIG. 3, the method 300 may include identifying that a first access counter associated with the first-level block of memory satisfies a first-level access threshold (block 330). For example, the CXL device may identify that a first-level hotness counter associated with the 1 GB block of memory satisfies a first-level threshold, as described above in connection with reference number 210. As further shown in FIG. 3, the method 300 may include identifying a second-level block of memory, of multiple second-level blocks of memory, that is associated with the portion of the memory based on identifying that the first access counter satisfies the first-level access threshold (block 340). For example, the CXL device may align the memory address indicated by the CXL.mem request to a 2 MB block of memory, as described above in connection with reference number 218. As further shown in FIG. 3, the method 300 may include identifying that a second access counter associated with the second-level block of memory does not satisfy a second-level access threshold (block 350). For example, the CXL device may identify that a second-level hotness counter associated with the 2 MB block of memory does not satisfy a second-level threshold, as described above in connection with reference number 222. As further shown in FIG. 3, the method 300 may include incrementing the second access counter (block 360). For example, the CXL device may increment a second-level hotness counter (e.g., a hotness counter configured to track accesses to the memory at a 2 MB granularity), as described above in connection with reference number 220.

The method 300 may include additional aspects, such as any single aspect or any combination of aspects described below and/or described in connection with one or more other methods or operations described elsewhere herein.

In a first aspect, the method 300 includes receiving, by the memory device from the host system, a second access request indicating that the portion of the memory is to be accessed by the memory device, identifying, by the memory device, that the second access counter associated with the second-level block of memory satisfies the second-level access threshold, identifying, by the memory device, a third-level block of memory, of multiple third-level blocks of memory, associated with the portion of the memory based on identifying that the second access counter satisfies the first-level access threshold, and incrementing, by the memory device, a third access counter associated with the third-level block of memory. For example, the CXL device may receive another CXL.mem request (as described above in connection with reference number 206) associated with the 2 MB block of memory, the CXL device may identify that the second-level hotness counter associated with the 2 MB block of memory satisfies the second-level threshold (as described above in connection with reference number 222), the CXL device may align the memory address indicated by the CXL.mem request to a 4 KB block of memory (as described above in connection with reference number 226), and/or the CXL device may increment a third-level hotness counter (e.g., a CBF-based hotness counter) associated with the 4 KB block of memory (as described above in connection with reference number 230).

In a second aspect, alone or in combination with the first aspect, at least one of the first access counter and the second access counter are associated with a hardware-based access counter, and the third access counter is associated with a counting-bloom-filter-based access counter. For example, the hotness counters associated with tracking the 1 GB blocks of memory and/or the 2 MB blocks of memory may be hardware-based counters, and/or the hotness counter associated with tracking the 4 KB blocks of memory may be a CBF-based counter.

In a third aspect, alone or in combination with one or more of the first and second aspects, a size of the first-level block of memory is 1 gigabyte, wherein a size of the second-level block of memory is 2 megabytes, and wherein a size of the third-level block of memory is 4 kilobytes.

In a fourth aspect, alone or in combination with one or more of the first through third aspects, a size of the first-level block of memory is larger than a size of the second-level block of memory. For example, a size of the first-level block of memory may be 1 GB, and/or a size of the second-level block of memory may be 2 MB, among other examples.

In a fifth aspect, alone or in combination with one or more of the first through fourth aspects, the method 300 includes adding, by the memory device, an identifier of the first-level block of memory to a first-level data structure based on identifying that the first access counter satisfies the first-level access threshold. For example, the CXL device may add an ID associated with the hot 1 GB block of memory to the Level 1 HN-L, as described above in connection with reference number 212 and the first-level structure indicated by reference number 238 in FIGS. 2D-2E.

In a sixth aspect, alone or in combination with one or more of the first through fifth aspects, the method 300 includes receiving, by the memory device from the host system, a second access request indicating that the portion of the memory is to be accessed by the memory device, identifying, by the memory device, that the second access counter associated with the second-level block of memory satisfies the second-level access threshold, and adding, by the memory device, an identifier of the second-level block of memory to a second-level data structure based on identifying that the second access counter satisfies the second-level access threshold. For example, the CXL device may receive another CXL.mem request (as described above in connection with reference number 206) associated with the 2 MB block of memory, the CXL device may identify that the second-level hotness counter associated with the 2 MB block of memory satisfies the second-level threshold (as described above in connection with reference number 222), and/or the CXL device may add an ID associated with the hot 2 MB block of memory to the Level 2 HN-L, as described above in connection with reference number 224 and the second-level structure indicated by reference number 240 in FIGS. 2D-2E.

In a seventh aspect, alone or in combination with one or more of the first through sixth aspects, the method 300 includes identifying, by the memory device, that a monitoring period has elapsed, and reducing, by the memory device, a value of the first access counter and a value of the second access counter based on identifying that the monitoring period has elapsed. For example, based on configuration indicated by a CXL host (e.g., host system 105) to the CXL device via one or more registers or otherwise, the CXL device may reset the first-level hotness counter and/or the second-level access counter at the end of an epoch, may reduce the first-level hotness counter and/or the second-level access counter at the end of the epoch according to a configured reduction factor, and/or may otherwise age the first-level hotness counter and/or the second-level access counter at the end of the epoch.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

In some implementations, a memory device includes one or more components configured to: receive, from a host system, a first access request indicating that a portion of a memory is to be accessed by the memory device; identify a first-level block of memory, of multiple first-level blocks of memory, that is associated with the portion of the memory; identify that a first access counter associated with the first-level block of memory satisfies a first-level access threshold; identify a second-level block of memory, of multiple second-level blocks of memory, that is associated with the portion of the memory based on identifying that the first access counter satisfies the first-level access threshold; identify that a second access counter associated with the second-level block of memory does not satisfy a second-level access threshold; and increment the second access counter.

In some implementations, a method includes receiving, by a memory device from a host system, a first access request indicating that a portion of a memory is to be accessed by the memory device; identifying, by the memory device, a first-level block of memory, of multiple first-level blocks of memory, that is associated with the portion of the memory; identifying, by the memory device, that a first access counter associated with the first-level block of memory satisfies a first-level access threshold; identifying, by the memory device, a second-level block of memory, of multiple second-level blocks of memory, that is associated with the portion of the memory based on identifying that the first access counter satisfies the first-level access threshold; identifying, by the memory device, that a second access counter associated with the second-level block of memory does not satisfy a second-level access threshold; and incrementing, by the memory device, the second access counter.

In some implementations, a compute express link (CXL) compliant memory device includes one or more components configured to: receive, from a host system, a first access request indicating that a portion of a memory is to be accessed by the CXL compliant memory device; identify a first-level block of memory, of multiple first-level blocks of memory, that is associated with the portion of the memory; increment a first hotness counter associated with the first-level block of memory; identify that the first hotness counter satisfies a first-level hotness threshold; add an identifier of the first-level block of memory to a first-level hotlist based on identifying that the first hotness counter satisfies the first-level hotness threshold; receive, from the host system, a second access request indicating that the portion of the memory is to be accessed by the CXL compliant memory device; identify a second-level block of memory, of multiple second-level blocks of memory, that is associated with the portion of the memory; increment a second hotness counter associated with the second-level block of memory; identify that the second hotness counter satisfies a second-level hotness threshold; add an identifier of the second-level block of memory to a second-level hotlist based on identifying that the second hotness counter satisfies the second-level hotness threshold; receive, from the host system, a third access request indicating that the portion of the memory is to be accessed by the CXL compliant memory device; identify a third-level block of memory, of multiple second-level blocks of memory; increment a third hotness counter associated with the third-level block of memory; identify that the third hotness counter satisfies a third-level hotness threshold; and add an identifier of the third-level block of memory to a third-level hotlist based on identifying that the third hotness counter satisfies the third-level hotness threshold.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host system, a first access request indicating that a portion of a memory is to be accessed by the memory device;
identify a first-level block of memory, of multiple first-level blocks of memory, that is associated with the portion of the memory;
identify that a first access counter associated with the first-level block of memory satisfies a first-level access threshold;
identify a second-level block of memory, of multiple second-level blocks of memory, that is associated with the portion of the memory based on identifying that the first access counter satisfies the first-level access threshold;
identify that a second access counter associated with the second-level block of memory does not satisfy a second-level access threshold; and
increment the second access counter.

2. The memory device of claim 1, wherein the one or more components are further configured to:
receive, from the host system, a second access request indicating that the portion of the memory is to be accessed by the memory device;
identify that the second access counter associated with the second-level block of memory satisfies the second-level access threshold;
identify a third-level block of memory, of multiple third-level blocks of memory, associated with the portion of the memory based on identifying that the second access counter satisfies the first-level access threshold; and
increment a third access counter associated with the third-level block of memory.

3. The memory device of claim 2, wherein at least one of the first access counter and the second access counter are associated with a hardware-based access counter, and
wherein the third access counter is associated with a counting-bloom-filter-based access counter.

4. The memory device of claim 3, wherein a size of the first-level block of memory is 1 gigabyte,
wherein a size of the second-level block of memory is 2 megabytes, and
wherein a size of the third-level block of memory is 4 kilobytes.

5. The memory device of claim 1, where a size of the first-level block of memory is larger than a size of the second-level block of memory.

6. The memory device of claim 1, wherein the one or more components are further configured to add an identifier of the first-level block of memory to a first-level data structure based on identifying that the first access counter satisfies the first-level access threshold.

7. The memory device of claim 6, wherein the one or more components are further configured to:
receive, from the host system, a second access request indicating that the portion of the memory is to be accessed by the memory device;
identify that the second access counter associated with the second-level block of memory satisfies the second-level access threshold; and
add an identifier of the second-level block of memory to a second-level data structure based on identifying that the second access counter satisfies the second-level access threshold.

8. The memory device of claim 1, wherein the one or more components are further configured to:
identify that a monitoring period has elapsed; and
reduce a value of the first access counter and a value of the second access counter based on identifying that the monitoring period has elapsed.

9. A method, comprising:
receiving, by a memory device from a host system, a first access request indicating that a portion of a memory is to be accessed by the memory device;
identifying, by the memory device, a first-level block of memory, of multiple first-level blocks of memory, that is associated with the portion of the memory;
identifying, by the memory device, that a first access counter associated with the first-level block of memory satisfies a first-level access threshold;
identifying, by the memory device, a second-level block of memory, of multiple second-level blocks of memory, that is associated with the portion of the memory based on identifying that the first access counter satisfies the first-level access threshold;
identifying, by the memory device, that a second access counter associated with the second-level block of memory does not satisfy a second-level access threshold; and
incrementing, by the memory device, the second access counter.

10. The method of claim 9, further comprising:
receiving, by the memory device from the host system, a second access request indicating that the portion of the memory is to be accessed by the memory device;
identifying, by the memory device, that the second access counter associated with the second-level block of memory satisfies the second-level access threshold;
identifying, by the memory device, a third-level block of memory, of multiple third-level blocks of memory, associated with the portion of the memory based on identifying that the second access counter satisfies the first-level access threshold; and
incrementing, by the memory device, a third access counter associated with the third-level block of memory.

11. The method of claim 10, wherein at least one of the first access counter and the second access counter are associated with a hardware-based access counter, and
wherein the third access counter is associated with a counting-bloom-filter-based access counter.

12. The method of claim 11, wherein a size of the first-level block of memory is 1 gigabyte,
wherein a size of the second-level block of memory is 2 megabytes, and
wherein a size of the third-level block of memory is 4 kilobytes.

13. The method of claim 9, where a size of the first-level block of memory is larger than a size of the second-level block of memory.

14. The method of claim 9, further comprising adding, by the memory device, an identifier of the first-level block of memory to a first-level data structure based on identifying that the first access counter satisfies the first-level access threshold.

15. The method of claim 14, further comprising:
receiving, by the memory device from the host system, a second access request indicating that the portion of the memory is to be accessed by the memory device;
identifying, by the memory device, that the second access counter associated with the second-level block of memory satisfies the second-level access threshold; and
adding, by the memory device, an identifier of the second-level block of memory to a second-level data structure based on identifying that the second access counter satisfies the second-level access threshold.

16. The method of claim 9, further comprising:
identifying, by the memory device, that a monitoring period has elapsed; and
reducing, by the memory device, a value of the first access counter and a value of the second access counter based on identifying that the monitoring period has elapsed.

17. A compute express link (CXL) compliant memory device, comprising:
one or more components configured to:
receive, from a host system, a first access request indicating that a portion of a memory is to be accessed by the CXL compliant memory device;
identify a first-level block of memory, of multiple first-level blocks of memory, that is associated with the portion of the memory;
increment a first hotness counter associated with the first-level block of memory;
identify that the first hotness counter satisfies a first-level hotness threshold;
add an identifier of the first-level block of memory to a first-level hotlist based on identifying that the first hotness counter satisfies the first-level hotness threshold;
receive, from the host system, a second access request indicating that the portion of the memory is to be accessed by the CXL compliant memory device;
identify a second-level block of memory, of multiple second-level blocks of memory, that is associated with the portion of the memory;
increment a second hotness counter associated with the second-level block of memory;
identify that the second hotness counter satisfies a second-level hotness threshold;
add an identifier of the second-level block of memory to a second-level hotlist based on identifying that the second hotness counter satisfies the second-level hotness threshold;
receive, from the host system, a third access request indicating that the portion of the memory is to be accessed by the CXL compliant memory device;
identify a third-level block of memory, of multiple second-level blocks of memory;
increment a third hotness counter associated with the third-level block of memory;
identify that the third hotness counter satisfies a third-level hotness threshold; and
add an identifier of the third-level block of memory to a third-level hotlist based on identifying that the third hotness counter satisfies the third-level hotness threshold.

18. The CXL compliant memory device of claim 17, wherein at least one of the first hotness counter and the second hotness counter are associated with a hardware-based hotness counter, and
wherein the third hotness counter is associated with a counting-bloom-filter-based hotness counter.

19. The CXL compliant memory device of claim 17, wherein a size of the first-level block of memory is 1 gigabyte,
wherein a size of the second-level block of memory is 2 megabytes, and
wherein a size of the third-level block of memory is 4 kilobytes.

20. The CXL compliant memory device of claim 17, wherein the one or more components are further configured to:
identify that a hotness counting period has elapsed; and
reduce a value of the first hotness counter, a value of the second hotness counter, and a value of the third hotness counter based on identifying that the hotness counting period has elapsed.
